(19) United States
(12) Patent Application Publication
(10) Pub. No.: US 2022/0235956 A1
(43) Pub. Date: Jul. 28, 2022

(54) GRADUALLY-CHANGING TWIN-TURBOCHARGED SUCTION PURIFIER

(71) Applicant: Shenzhen Tri-Tech technology Co., Ltd., Shenzhen (CN)

(72) Inventors: Shaoguo HUANG, Shenzhen (CN); Mingqun XIONG, Shenzhen (CN)

(21) Appl. No.: 17/214,780

(22) Filed: Mar. 26, 2021

(30) Foreign Application Priority Data
Jan. 28, 2021 (CN) 2021101079078

(51) Int. Cl. F24F 8/183; F24F 11/88; F24F 8/80; F24F 13/20; F24F 8/108

(52) U.S. Cl. CPC F24F 8/183; F24F 11/88; F24F 8/108; F24F 13/20; F24F 8/80

(57) ABSTRACT

The present disclosure relates to the technical field of air purifiers, and in particular to a gradually-changing twin-turbocharged suction purifier. The gradually-changing twin-turbocharged suction purifier includes a housing combination, a twin-turbocharging assembly, a filter screen cylinder combination and a rotary end cover, wherein the twin-turbocharging assembly is mounted inside the housing combination, the filter screen cylinder combination is disposed between the housing combination and the twin-turbocharging assembly, the twin-turbocharging assembly includes a top screen combination, a large fan combination, a cone-shaped small fan combination, an internal support combination and a power connection box combination. A cone-shaped gradually-changing air channel is adopted between the large fan combination and the small fan combination to reduce surge and noise of air flow. Under the same purification performance conditions, the purifier of the present disclosure may generate the smallest noise.

### CROSS-REFERENCE TO RELATED APPLICATION

This application claims priority from Chinese patent application 2021101079078 filed Jan. 28, 2021, the content of which is incorporated herein in the entirety by reference.

### TECHNICAL FIELD

The present disclosure relates to the technical field of air purifiers, and in particular to a gradually-changing twin-turbocharged suction purifier.

### BACKGROUND

A high efficiency particulate air filter (HEPA) achieves a purpose of purifying indoor air by repeating the following process: a motor is used to drive an air-driven or air-compressed component (such as fan blades or a wind wheel) to rotate so as to generate a certain negative pressure in a certain space (inside the filter), and air of a purified space (room) enters the negative pressure space through a HEPA filter screen mounted at an air inlet of the negative pressure space, and then is discharged back to the purified space through an air outlet of the negative pressure space.

At present, there are three major types of HEPA filters available in the market. The first type of HEPA filter is a filter with a motor driving a forward centrifugal wind wheel, the second type of HEPA filter is a filter with a motor driving a backward centrifugal wind wheel, and the third type of HEPA filter is a filter with a motor driving an axial-flow fan blade. However, these types of filters all have very severe defects. During operation of these types of filters, their fans may generate large noise with high power consumption. Further, the products are large in size.

### SUMMARY

Based on this, it is necessary to provide a gradually-changing twin-turbocharged suction purifier to solve the problems that the fans of the existing filters generate large noise with high power consumption during operation and the products are also large in size.

A gradually-changing twin-turbocharged suction purifier includes a housing combination, a twin-turbocharging assembly, a filter screen cylinder combination and a rotary end cover. The twin-turbocharging assembly is mounted in the housing combination. The filter screen cylinder combination is disposed between the housing combination and the twin-turbocharging assembly to filter external air. The rotary end cover is mounted at the bottom of the housing combination.

The twin-turbocharging assembly is used to perform rotational compression and purification for air entering the housing combination. The twin-turbocharging assembly includes a top screen combination, a large fan combination, a cone-shaped small fan combination, an internal support combination and a power connection box combination. The large fan combination and the small fan combination are used to compress and purify air. The power connection box combination is used to connect an external power source and supply power to the large fan combination and the small fan combination respectively, so that the large fan combination and the small fan combination can be operated to purify air. The top screen combination is used to filter and discharge the purified air.

As a further solution of the present disclosure, the top screen combination includes a top air discharge screen fixed on the housing combination, a top air discharge hood mounted at the bottom of the top air discharge screen, and an air quality lamp hood mounted on the top air discharge hood.

As a further solution of the present disclosure, a control panel cover is disposed on the top air discharge screen, and a control printed circuit board assembly (PCBA) board is disposed on the control panel cover. A control button is disposed on the control panel cover which is electrically connected with the power connection box combination. The control PCBA board controls the operations of the large fan combination and the small fan combination, respectively.

As a further solution of the present disclosure, the large fan combination includes a large fan hood fixed on the top screen combination, large turbine blades that are disposed in the large fan hood to perform rotational compression for air, and a first motor for driving the large turbine blades to rotate.

As a further solution of the present disclosure, the small fan combination includes a cone-shaped small fan hood fixed on the large fan combination, a motor bracket mounted at the top of the small fan hood, small cone-shaped turbine blades that are disposed inside the small fan hood and rotatably mounted on the motor bracket to perform rotational compression for air, and a second motor that is mounted on the motor bracket to drive the small turbine blades to rotate. The opening of the small fan hood is of a cone shape.

As a further solution of the present disclosure, the large turbine blades and the small turbine blades are connected in tandem and rotated in opposite directions.

As a further solution of the present disclosure, the first motor and the second motor are electrically connected with the control PCBA board, respectively.

As a further solution of the present disclosure, the internal support combination includes an upper support portion mounted on the small fan combination and a lower support portion mounted on the power connection box combination.

As a further solution of the present disclosure, the housing combination includes a top housing, an inlet air screen assembly assembled at the bottom of the top housing, and a seat that is disposed at the bottom of the inlet air screen assembly to fasten the inlet air screen assembly.

As a further solution of the present disclosure, the inlet air screen assembly is formed by four arc-shaped inlet air screens, and catches are disposed at connection sides of the four inlet air screens to tightly lock the inlet air screens with each other.

Compared with the prior art, the present disclosure has the following beneficial effects. A cone-shaped gradually-changing air channel adopted between the large wind wheel and the small wind wheel may reduce surge and noises of air flow. At the same time, the large turbine blades and the small turbine blades are connected in tandem and rotated in opposite directions so as to ensure the air tightness and efficiency of the fan system. In this case, the two wind wheels can reach a sufficient negative pressure value and a sufficient air flow rate at a relatively low rotation speed. Since the rotation speed of the wind wheel is relatively low, the noise generated during rotation is also small, and the cone-shaped small turbine structure may improve the air tightness and the air flow rate of the air channel. Under the same purification performance conditions, the purifier of the present disclosure may generate the smallest noise. Further, the product has a minimum volume and a beautiful and simple appearance and thus is suitable for many occasions. At the same time, the product has a scientific and reasonable structure, and is simple and reliable, easy to assemble and convenient in replacement of filter screen.

The additional aspects and advantages of the present disclosure will be partially given in the following descriptions, some of which will become apparent from the following descriptions or will be known by practicing the present disclosure.

### BRIEF DESCRIPTION OF THE DRAWINGS

To describe the technical solutions in the examples of the present disclosure or in the prior art more clearly, drawings required in descriptions of the examples of the present disclosure or the prior art will be briefly introduced below. It is apparent that the drawings described below are merely some examples of the present disclosure and other drawings may also be obtained by those of ordinary skill in the art based on these drawings without paying creative work.

FIG. 1 is an exploded view of a structure of the present disclosure.

FIG. 2 is an exploded view of a structure of a twin-turbocharging assembly according to an example of the present disclosure.

FIG. 3 is an exploded view of a structure of a large fan combination according to an example of the present disclosure.

FIG. 4 is an exploded view of a structure of a small fan combination according to an example of the present disclosure.

FIG. 5 is an exploded view of a structure of a top air discharge screen according to an example of the present disclosure.

FIG. 6 is an exploded view of a structure of assembling a large fan combination and a small fan combination according to an example of the present disclosure.

FIG. 7 is a schematic diagram of a structure of an internal support combination according to an example of the present disclosure.

FIG. 8 is an exploded view of a structure of a housing combination according to an example of the present disclosure.

FIG. 9 is an exploded view of a structure of an inlet air screen assembly according to an example of the present disclosure.

FIG. 10 is a schematic diagram of a structure of a seat according to an example of the present disclosure.

### DETAILED DESCRIPTION OF THE EMBODIMENTS

The technical solutions in the examples of the present disclosure will be clearly and fully described below. It is apparent that the described examples are merely part of examples of the present disclosure rather than all examples. Other examples achieved by those of ordinary skill in the art based on the examples in the present disclosure without paying creative work shall all fall into the scope of protection of the present disclosure.

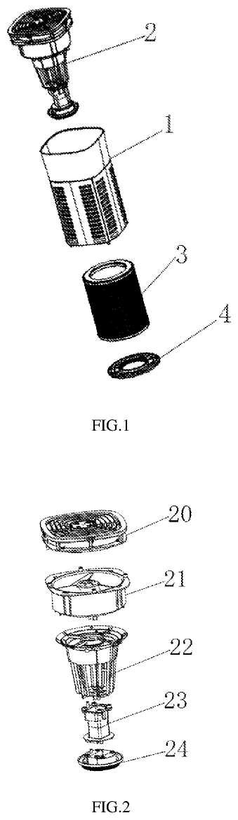

As shown in FIGS. 1-2, in an example of the present disclosure, a gradually-changing twin-turbocharged suction purifier includes a housing combination 1, a twin-turbocharging assembly 2, a filter screen cylinder combination 3 and a rotary end cover 4. The twin-turbocharging assembly 2 is mounted inside the housing combination 1. The filter screen cylinder combination 3 is disposed between the housing combination 1 and the twin-turbocharging assembly 2 to filter external air. The rotary end cover 4 is mounted at the bottom of the housing combination 1. The twin-turbocharging assembly 2 is used to perform rotational compression and purification for air entering the housing combination 1. The twin-turbocharging assembly 2 includes a top screen combination 20, a large fan combination 21, a cone-shaped small fan combination 22, an internal support combination 23, and a power connection box combination 24. The large fan combination 21 and the small fan combination 22 are used to compress and purify air. Components, i.e., fan blades in the large fan combination 21 and the small fan combination 22 are connected in tandem and rotated in opposite directions. The power connection box combination 24 is used to connect an external power source to supply power to the large fan combination 21 and the small fan combination 22 respectively, so that the large fan combination 21 and the small fan combination 22 are operated to purify air. The top screen combination 20 is used to filter and discharge the purified air.

In the above gradually-changing twin-turbocharged suction purifier, a cone-shaped gradually-changing air channel adopted between the large fan combination 21 and the small fan combination 22 may reduce the surge and noise of the air flow. At the same time, the components, i.e., the fan blades in the large fan combination 21 and the small fan combination 22 are connected in tandem and rotated in opposite directions to ensure the air tightness and the efficiency of the fan system. In this way, two wind wheels can reach a sufficient negative pressure value and a sufficient air flow rate at a relatively low rotation speed. Since the rotation speed of the wind wheel is relatively low, the noise generated during rotation is also small, and the cone-shaped structure of the small fan combination 22 may improve the air tightness and the air flow rate of the air channel.

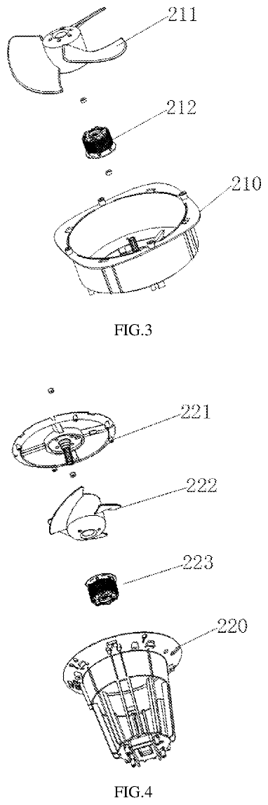

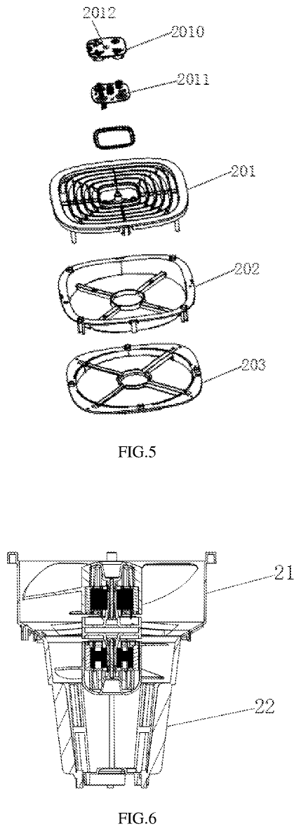

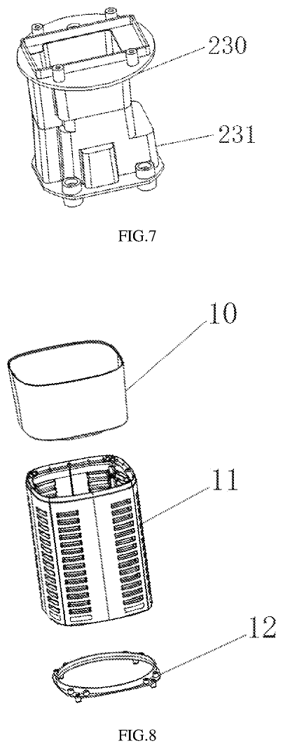

The twin-turbocharging assembly 2 is a main part of the purifier of the present disclosure, which is used to perform rotational compression and purification for air entering the housing combination 1. Each of the top screen combination 20, the large fan combination 21, the small fan combination 22, the internal support combination 23 and the power connection box combination may be assembled independently according to a fool-proof structure design to ensure production efficiency and assembly quality. All internal leads required for machine circuits are fixedly mounted on the twin-turbocharging assembly 2, and a power socket is mounted on the power connection box combination 24 at bottom. Therefore, the entire machine can be used safely and reliably. As shown in FIGS. 2-7, the top screen combination 20 includes a top air discharge screen 201 fixed on the housing combination 1, a top air discharge hood 202 mounted at the bottom of the top air discharge screen 201, and an air quality lamp hood 203 mounted on the top air discharge hood 202. The top air discharge hood 202 is disposed to discharge purified air. A control panel cover 2010 is disposed on the top air discharge screen 201, and a control PCBA board 2011 is disposed on the control panel cover 2010. A control button 2012 is disposed on the control panel cover 2010 which is electrically connected with the power connection box combination 24. The control PCBA board 2011 controls the operations of the large fan combination 21 and the small fan combination 22, respectively.

Further, the large fan combination 21 includes a large fan hood 210 fixed on the top screen combination 20, large turbine blades that are disposed inside the large fan hood 210 to rotationally compress air, and a first motor 212 for driving the large turbine blades 211 to rotate. The small fan combination 22 includes a cone-shaped small fan hood 220 fixed on the large fan combination 21, a motor bracket 221 mounted at the top of the small fan hood 220, cone-shaped small turbine blades 222 that are disposed inside the small fan hood 220 and rotatably mounted on the motor bracket 221 to rotationally compress air, and a second motor 223 that is mounted on the motor bracket 221 to drive the small turbine blades 222 to rotate. The opening of the small fan hood 220 is of a cone shape. The large turbine blades 211 and the small turbine blades 222 are connected in tandem and rotated in opposite directions. The first motor 212 and the second motor 223 are operated by the control PCBA board 2011, respectively. An operator performs operation using the control button 2012 on the control panel cover 2010 to control the rotation speeds of the first motor 212 and the second motor 223, so as to achieve an air purifying speed and an air purification quantity required by the operator. The internal support combination 23 includes an upper support portion 230 mounted on the small fan combination 22 and a lower support portion 231 mounted on the power connection box combination 24. It is to be noted that the large turbine blades 211 and the small turbine blades 222 are designed to be connected in tandem and rotated in opposite direction, so that the blades may be replaced according to client's requirements regardless of blade number, blade size and blade shape of the large and small turbine blades. At the same time, the structural design of the gradually-changing air channel between the large turbine blades 221 and the small turbine blades 222 and the cone-shaped structural design of the small turbine blades 222 both fall within the scope of protection of the present disclosure regardless of the sizes and shapes of the air channel and the blade. It is to be further noted that the modular structural design in which different air purification quantities are realized by selecting/unselecting the internal support combination 23, adjusting heights of the inlet air screen and the filter screen and adjusting the rotation speed of the motors fall within the scope of protection of the present disclosure regardless of the size and shape of the internal support and the sizes of the inlet air screen and the filter screen.

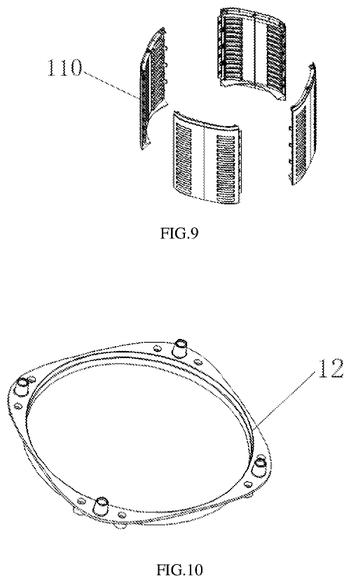

With reference to FIGS. 8-10, to ensure a large air inlet area, the housing combination 1 includes a top housing 10, an inlet air screen assembly 11 assembled at the bottom of the top housing 10, and a seat 12 that is disposed at the bottom of the inlet air screen assembly 11 to fasten the inlet air screen assembly 11. The inlet air screen assembly 11 is formed by four arc-shaped inlet air screens 110, and catches are disposed at connection sides of the four inlet air screens 110 to tightly lock the inlet air screens 110 with each other. The housing combination 1 of the present machine is simple and compact, and can be made relatively small in the entire size under the same performance conditions. Four identical inlet air screens 110 disposed at bottom can fully ensure a sufficiently large air inlet area and a sufficiently small air inlet resistance. At the same time, the air discharge screen with a large opening is provided with ferrule-shaped grids to ensure a small air outlet resistance.

Firstly, each part of the present disclosure may be assembled independently; then, the twin-turbocharging assembly 2 is sleeved into the housing combination 1 for fixing; next, the filter screen cylinder combination 3 is disposed in a space between the housing combination 1 and the twin-turbocharging assembly 2; finally, the bottom rotary end cover 4 and the power connection box combination 24 at the bottom of the twin-turbocharging assembly 2 are locked tightly by rotation. During use, an output connector of a direct current adapter (24V) may be plugged into a socket on the power connection box combination 24 at the bottom of the twin-turbocharging assembly 2. The structural design of connecting a power line to the twin-turbocharging assembly 2 from the power connection box combination 24 at bottom and connecting the power line from the center of the filer screen cylinder combination 3 to the machine ensures that the power source of alternating current or direct current can be used. Further, the purifier of the present disclosure adopts a power supply mode of a DC adapter (input: 120V/220V AC, output: 24V DC), and the motor is an external rotor DC brushless motor, thereby fully coordinating the contradiction between the air flow rate and the air resistance in the internal air channel.

It is apparent to those skilled in the art that the present disclosure is not limited to the details of the above examples, and can be implemented in other specific forms without departing from the spirit or basic characteristics of the present disclosure. Therefore, the above examples shall be considered as illustrative and non-limiting from any point of view. The scope of the present disclosure is defined by the appended claims rather than the above descriptions, and thus, all changes falling within the meanings and scope of equivalent elements of the claims shall be included in the present disclosure. No drawing symbols in the claims shall be regarded as limiting the involved claims.

1. A gradually-changing twin-turbocharged suction purifier, comprising a housing combination (1), a twin-turbocharging assembly (2), a filter screen cylinder combination (3) and a rotary end cover (4), wherein the twin-turbocharging assembly (2) is mounted inside the housing combination (1), the filter screen cylinder combination (3) is disposed between the housing combination (1) and the twin-turbocharging assembly (2) to filter external air, and the rotary end cover (4) is mounted at the bottom of the housing combination (1);
the twin-turbocharging assembly (2) is used to perform rotational compression and purification for air entering the housing combination (1), the twin-turbocharging assembly (2) comprises a top screen combination (20), a large fan combination (21), a cone-shaped small fan combination (22), an internal support combination (23) and a power connection box combination (24), the large fan combination (21) and the small fan combination (22) are used to compress and purify air, the power connection box combination (24) is used to connect an external power source to supply power to the large fan combination (21) and the small fan combination (22) respectively, so that the large fan combination (21) and the small fan combination (22) are operated to purify air, and the top screen combination (20) is used to filter and discharge the purified air.

2. The gradually-changing twin-turbocharged suction purifier according to claim 1, wherein the top screen combination (20) comprises a top air discharge screen (201) fixed on the housing combination (1), a top air discharge hood (202) mounted at the bottom of the top air discharge screen (201), and an air quality lamp hood (203) mounted on the top air discharge hood (202).

3. The gradually-changing twin-turbocharged suction purifier according to claim 2, wherein a control panel cover (2010) is disposed on the top air discharge screen (201) and a control printed circuit board assembly (PCBA) board (2011) is disposed on the control panel cover (2010), a control button (2012) is disposed on the control panel cover (2010) which is electrically connected with the power connection box combination (24), and the control PCBA board (2011) controls the operations of the large fan combination (21) and the small fan combination (22) respectively.

4. The gradually-changing twin-turbocharged suction purifier according to claim 1, wherein the large fan combination (21) comprises a large fan hood (210) fixed on the top screen combination (20), large turbine blades (211) that are disposed in the large fan hood (210) to rotationally compress air, and a first motor (212) for driving the large turbine blades (211) to rotate.

5. The gradually-changing twin-turbocharged suction purifier according to claim 1, wherein the small fan combination (22) comprises a cone-shaped small fan hood (220) fixed on the large fan combination (21), a motor bracket (221) mounted at the top of the small fan hood (220), cone-shaped small turbine blades (222) that are disposed inside the small fan hood (220) and rotatably mounted on the motor bracket (221) to rotationally compress air, and a second motor (223) that is mounted on the motor bracket (221) to drive the small turbine blades (222) to rotate, and an opening of the small fan hood (220) is of a cone shape.

6. The gradually-changing twin-turbocharged suction purifier according to claim 4, wherein the large turbine blades (211) and the small turbine blades (222) are connected in tandem and rotated in opposite directions.

7. The gradually-changing twin-turbocharged suction purifier according to claim 3, wherein the first motor (212) and the second motor (223) are electrically connected with the control PCBA board (2011) respectively.

8. The gradually-changing twin-turbocharged suction purifier according to claim 1, wherein the internal support combination (23) comprises an upper support portion (230) mounted on the small fan combination (22) and a lower support portion (231) mounted on the power connection box combination (24).

9. The gradually-changing twin-turbocharged suction purifier according to claim 1, wherein the housing combination (1) comprises a top housing (10), an inlet air screen assembly (11) assembled at the bottom of the top housing (10), and a seat (12) that is disposed at the bottom of the inlet air screen assembly (11) to fasten the inlet air screen assembly (11).

10. The gradually-changing twin-turbocharged suction purifier according to claim 9, wherein the inlet air screen assembly (11) is formed by four arc-shaped inlet air screens (110), and catches are disposed at connection sides of the four inlet air screens (110) to tightly lock the inlet air screens (110) with each other.

11. The gradually-changing twin-turbocharged suction purifier according to claim 5, wherein the large turbine blades (211) and the small turbine blades (222) are connected in tandem and rotated in opposite directions.

12. The gradually-changing twin-turbocharged suction purifier according to claim 4, wherein the first motor (212) and the second motor (223) are electrically connected with the control PCBA board (2011) respectively.

13. The gradually-changing twin-turbocharged suction purifier according to claim 5, wherein the first motor (212) and the second motor (223) are electrically connected with the control PCBA board (2011) respectively.
